(19) United States
(12) Patent Application Publication
(10) Pub. No.: US 2024/0394751 A1
(43) Pub. Date: Nov. 28, 2024

(54) COMPUTER-ASSISTED RELEASE CONTENT AND DISTRIBUTION

(71) Applicant: Digital Media Innovations, LLC, Omaha, NE (US)

(72) Inventors: Donovan Isaiah Orn, Omaha, NE (US); David John Wippich, San Jose, CA (US)

(21) Appl. No.: 18/324,864

(22) Filed: May 26, 2023

(51) Int. Cl. G06Q 30/0241; G06F 3/04842; G06F 40/289; G06F 40/40; G06Q 30/0242

(52) U.S. Cl. CPC G06Q 30/0276; G06F 3/04842; G06F 40/289; G06F 40/40; G06Q 30/0244

(57) ABSTRACT

A release generation system assists a user in automatically generating content for distribution to appropriate distribution channels and optimizing the content for increased engagement by those channels. The user may provide a set of core concepts and select a framing such as a tone and/or keywords for the release. A release is automatically generated based on the framing and the core concepts, which may then be modified by the user in view of standards grading. Distribution and recipients of the release may then be selected based on predicted metrics and destination engagement with the release.

### BACKGROUND

This disclosure relates generally to generating content for release and distribution, and more particularly to automated systems for improving targeting, drafting, and distributing such content.

Content creation and distribution is a challenging task, particularly for marketing and public relations. One tool for distributing information is a press release, which is typically a relatively short article describing developments for an entity, such as a company. In today's media industry, there are many types of press releases that may relate to different types of information, such as general news, regulatory news, new hires (including expert hires), acquisitions, new business ventures, events, research findings, awards, rebrandings, and so forth. In general, press releases may include textual content describing the information to be conveyed and may also include images, pictures, links, and other multimedia content as well.

In today's world in the media industry, press releases are a great tool for spreading information. A captivating piece of copy in the press release will capture the attention of journalists or news channels and influencers, who will hopefully choose to run the story in their respective media outlets. This helps the release reach a wider audience (including potential customers). A well-written press release, when distributed to the right distribution channels and media outlets, can help build buzz, generate leads, and even drive website traffic. In contrast, ineffective press releases may be relatively poor in gathering attention from desired outlets. In practice, not only may it take a substantial amount of time to create an effective press release, but it may also be particularly difficult for authors and others responsible for press releases to know in advance whether they are creating effective content that will be attractive to the right audience. Without effective guidance, such users may be guided by intuition or personal experience in drafting and distributing releases.

### SUMMARY

To improve the creation and distribution of press releases, users interact with a press release generation system that coordinates various computer models to support effective drafting and distribution of press releases. In particular, the system and its integration with various computer models support generation of press releases that may simultaneously convey the essential informative content while also using terminology tuned to convey a particular framing of the information targeted to most-relevant destinations, which may include further dissemination and related independent publication by additional actors. The release may also be evaluated with respect to objective release quality standards. In addition to improving the drafting process for a release itself, the integrated consideration of destinations and framing may permit the release to optimize not only for immediate audience metrics (e.g., a size of the audience who viewed the release), but also for downstream actions by desired destinations (e.g., further publications and/or actors who may republish, repackage, or create original reporting based on the release).

To generate the release, the system interfaces with a user to determine the core content for the release. The core content represents the “facts” and other substantive information to be conveyed with the release. In addition to the substantive content, the system coordinates with the user to select a “framing” for the release, describing a tone and/or associated keywords desired for the release. The framing may thus represent a tone, mood, or descriptive style and associated terms for presenting the content. In addition to a user selection of a tone, models may suggest and evaluate a framing for the user based on predictions of audience engagement.

The system may assist in drafting of the release by inputting the core content and framing to a large language model configured to generate an expanded output in the form of a press release. The system may then present the generated release to the user for further revision and editing, during which the user may be presented real-time feedback on user modifications, for example to suggest further terminology and phrasing consistent with the framing and based on audience predictions.

The system thus allows a user to create a press release that leverages computer models in selecting a framing that may include assistance with keywords and phrases that increase audience engagement. In addition, the system may evaluate the release and/or framing with respect to particular distribution channels and particular “destinations” (target journalist and analyst). The system integrates the data for suggesting a framing, including “tone” selection and assistance with “keywords” while drafting the press-release and further suggest “destinations” to improve distribution and downstream response to the release. The system also calculates a score or “grade” for the press release to evaluate additional objective measures of release quality. With this draft press release Grader, the user may view immediate feedback on the draft based on industry standard best practices.

This disclosure thus provides a system for collecting, maintaining and training computer models with large datasets from different sources including but not limited to historical press release “tone” across companies or the industry niches, historical press release analytics data in response to “keywords and phrases” used in press releases and placement and related reach data generated from distributing the release to specific “destinations.” More particularly a system is disclosed that uses the historical data for press releases and articles written from them as learning parameters for future releases based on the related popularity of the historical press releases and to generate data for training a set of AI models. In various embodiments, the system coordinates and orchestrates application of this combination of models trained on the historical data sets to help and assist users to draft effective press releases and distribute them. By combining the various models together, users may quickly determine destinations, framing for a release, draft the release, evaluate its quality and predicted metrics, and distribute the release.

### BRIEF DESCRIPTION OF THE DRAWINGS

FIG. 1 illustrates a system environment for generation and distribution of press releases, according to one embodiment.

FIG. 2 illustrates an example distribution flow for a press release, according to one or more embodiments.

FIG. 3 shows an example system diagram of the release generation system 110, according to one or more embodiments.

FIG. 4 provides an interaction diagram for using and fine-tuning a large language model for generating effective press releases, according to one or more embodiments.

FIG. 5 is an example flowchart for automating generation and distribution of a press release, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

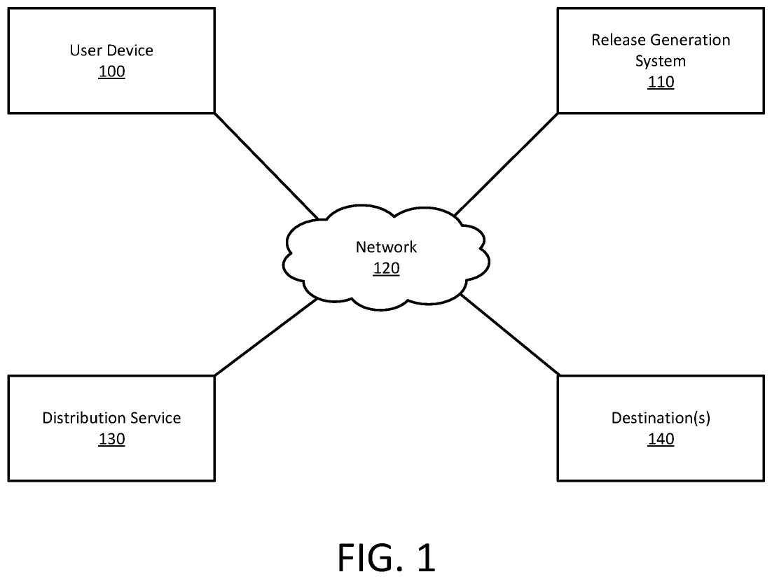

FIG. 1 illustrates a system environment for generation and distribution of press releases, according to one embodiment. A user of a user device 100 may interact with a release generation system 110 to create and distribute a press release. A press release may include a package of content that may be distributed together, and may include a title, textual content, images, audio, video, links, and so forth. The press release may be instantiated as a message (e.g., as an email), a webpage (or other accessible document), or a package that may be disseminated to interested recipients. The release generation system 110 includes various computer models and orchestration thereof to create releases with a desired framing to convey content of the press release in a way of interest to audiences and to select distributions and desired destinations for the release. As such, the release generation system 110 may use computer models and interfaces with the user of the user device 100 to coordinate creation of an effective release in view of desired destinations. The release generation system 110 may both aid in drafting a release of interest to specific destinations as well as identifying a destination of interest to a particular release. Components and additional features of the release generation system 110 are further discussed below.

The release generation system 110 may communicate with the user device 100, along with other devices in the environment, via a network 120. The network 120 provides a communication channel for devices to send and receive messages and may include any suitable way for conveying such messages.

The distribution service 130 receives a press release for publication and distributes the press release via designated distribution channels. The distribution may vary according to different press releases and may be specified for each press release. The distribution channels may include active and passive distribution channels. In active distribution channels, the press release (or a notification thereof) is sent to recipients directly, providing a notification of the release. Such active notifications may include physical or electronic mail, addition of the press release to a newsletter or mailer, and other types of direct messaging to recipients. Different active distribution channels may represent different groups and/or types of recipients for the mail; for example, press releases relating to company earnings and corporate affairs may be sent in an active distribution channel to a company's investors or stockholders, while press releases relating to a new product release may be sent to an active distribution channel to a company's wholesale distribution partners. Passive distribution channels may include making the press release available to be accessed by an audience. Passive distribution channels may include, for example, posting the press release to a website, adding the press release to a database, posting the release to a social media network, and so forth. In general, the different distribution channels may represent different ways for providing the press release to different groups of users.

In many instances, one objective of the press release is to be included by one or more destinations 140 in further dissemination of press release content via related destination channels and increase attention for the content of the press release. The individual destination 140 may be a specified recipient for a selected distribution channel or may independently access the press release (e.g., for a passive distribution channel) and determine to further distribute information related to the press release. The destinations 140 typically represent independent entities, such as media companies, publishers, journalists, popular figures, program hosts (e.g., for broadcast television or online audio/video streaming programs) and others, who may independently decide whether to further promote the press release content to associated destination channels. For example, based on a press release discussing a new initiative and prominent hire, a journalist (as a destination 140) may publish an article discussing the initiative in relation to other industry trends. The published article may then become available to an audience when published via destination channels affiliated with the journalist and represent the additional channels through which information related to the press release may be further disseminated. Destination channels thus represent “earned media” that may be influenced by the destinations 140 for the press release, such that an author of a press release may desire further publication of the press release content via one or more of the destinations 140 to one or more destination channels. However, the author of the press release may have limited to no control of whether the destination 140 further publishes anything related to the press release to related destination channels. Such destination channels may include a variety of types of ways in which additional persons/entities may increase visibility or engagement with the press release, such as users mentioning, referencing, sharing, reviewing, reporting on, or otherwise providing an additional channel for distributing information about the press release.

Often, further distribution by destinations 140 to such destination channels represents highly sought-after results of an effective press release, usually representing a high level of engagement and interest with the press release. However, as each potential destination channel 140 typically represents an independent entity exercising its own judgment for what content to distribute on the destination channels 140, it may be difficult for the author of the press release to intentionally target a particular destination channel 140 via the content of the press release itself. As discussed more fully below, the release generation system 110 may use various audience and destination metrics to train and apply models that enable generating and distributing press releases with effective content for distribution channels and destination channels.

The environment shown in FIG. 1 omits additional devices and systems for clarity and simplicity of description. For example, the distribution service 130 in some embodiments is incorporated in a system that also includes the release generation system 110. In addition, the various types of channels through which the press release or subsequent data (e.g., from the destination channels) are not shown, and may include various types of communication systems or devices, such as broadcast media, electronic and physical distribution systems, social networks, newsfeed and newswire services, and so forth. Likewise, additional devices and systems are omitted for the various audiences and other users who may receive or otherwise access or engage with the press release.

While the present disclosure generally relates to the creation and distribution of a “press release,” particularly in view of one or more destinations 140 and further distribution of information to destination channels, the principles of the present disclosure apply generally to customizing a set of content that may be distributed to an audience and further distributed to additional users. Such content may include sequenced content, such as textual information or other tokens, along with non-sequenced content, such as images, video, or other content that may be generated and customized with respect to desired distribution properties.

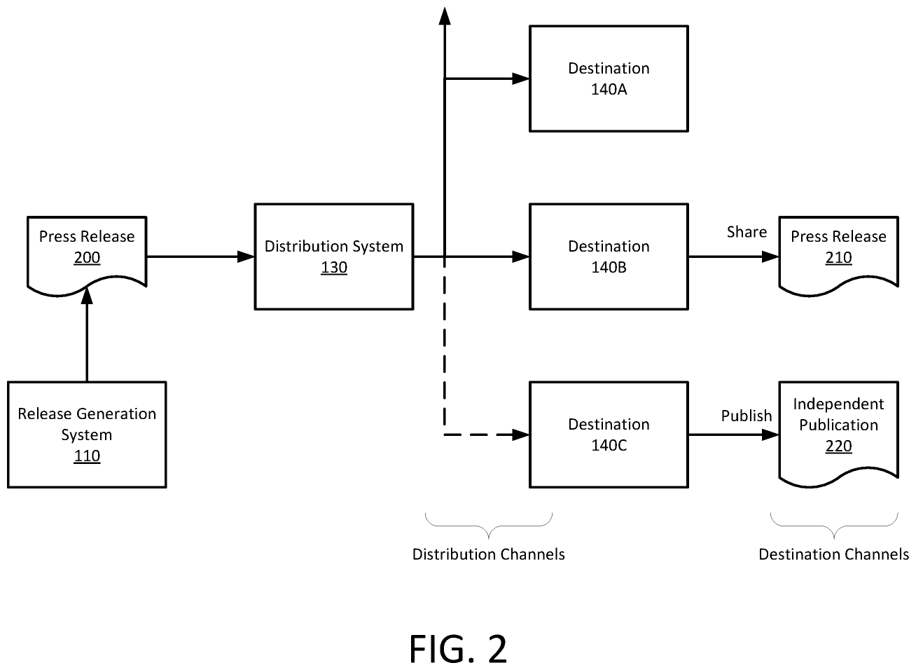

FIG. 2 illustrates an example distribution flow for a press release, according to one or more embodiments. After generation by the release generation system 110, a press release 200 may be provided to the distribution system 130 for distribution to the selected distribution channels for the press release 200. The distribution channels may include various means of distributing the press release, as indicated above. The distribution channels may include directly sending the press release to various desired destination channels 140, such as destinations 140A, 140B shown in FIG. 2. For example, this may represent sending the press release to individuals, entities, newsrooms, or other persons who may be interested in further publicizing the content of the press release and operate as target destinations for the press release. The press release may also be distributed to additional audiences, passively or actively, as shown in FIG. 2. In this example, of the destinations 140A-C shown in FIG. 2, destination 140C was not directly sent the press release, but may access the press release, e.g., from a passive distribution channel.

In the example shown in FIG. 2, destinations 140B and 140C further distributed information about the press release to respective distribution channels. In this example, destination 140B shared the press release 200 to its destination channels as press release 210. In some embodiments, a destination may share a press release verbatim, and in other embodiments may modify a press release, for example to condense or summarize the press release 200. Similarly, destination 140C further distributed an independent publication 220 to its destination channel(s) based in part on the press release. As discussed above, given the independent nature of these destinations 140, the release generation system 110 assists in intelligently catering a press release and its distribution to increase the likelihood of effective audience reception and interest by destinations 140.

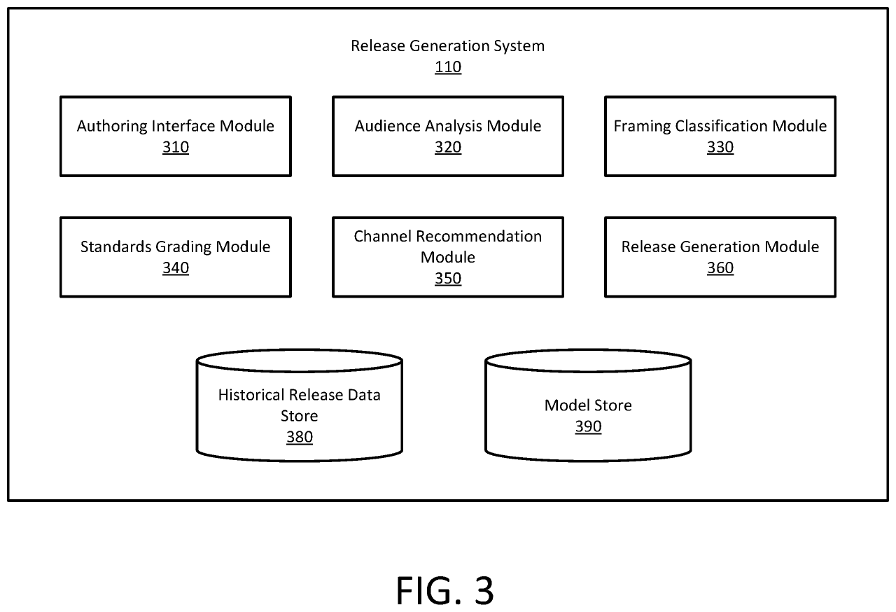

FIG. 3 shows an example system diagram of the release generation system 110, according to one or more embodiments. The release generation system 110 includes various computing modules and data stores for analyzing and generating press releases. The computing modules discussed herein are discussed for convenience with respect to particular computing functions and may be separated or combined in different ways in different embodiments. As such, the particular separation of functions discussed herein is provided for convenience; further embodiments may include more or fewer modules in different combinations or arrangements than shown in FIG. 3.

The data stores include a historical release data store 380 storing information about distributed releases and a set of computer models in a model store 390. In general, the computing modules may gather or otherwise generate data related to historical releases, generate and/or apply models based on the historical release data, and coordinate application of the models in generating and distributing a new release. The historical release data store 380 may thus include various data describing the press release content along with additional information describing the release and its performance that may be used to train relevant models for improving further releases. Each press release in the historical release data store 380 may thus include press release content (e.g., the distributed information of the release, such as its textual content, images, links, etc.), as well as associated metadata about the release (e.g., a particular author and/or entity distributing the release, tone, key terms, or topics), and response metrics describing performance of the release (e.g., with respect to audiences of the distribution channel and with respect to destination interactions with the content). Releases may also include information related to automatic generation of a press release (e.g., the inputs used for the release's generation), such as a framing (i.e., an input tone and/or keywords) and the core concepts to be conveyed by the release. These various types of data are further discussed below.

The computing modules may use and/or train one or more computer models that may be stored in the model store 390. In general, a computer model learns a set of parameters for converting a set of inputs to a set of outputs. The structure of the parameters may differ according to the particular computer model and may include different types of machine learning computer models according to the particular task. In general, the learned parameters are used to describe a relationship for combining or otherwise modifying values of inputs to generate values of outputs. Such models may include various neural networks which may include a number of hidden layers that generate or operate upon intermediate values (i.e., other than the input and output) within the network. Depending on the implementation, models may include fully connected layers, convolutional layers, activation layers, pooling layers, recurrent layers, attention layers, and so forth. Also depending on the particular model and its implementation, the models may include sequence-sequence models, large language models (e.g., transformers), classification models, and so forth. The computer models may be trained by any suitable technique according to the type of data and may include supervised and unsupervised learning based on a set of training data.

Additional or fewer data stores and modules may also be included at release generation system 110 and features or functionalities of them may be accessed at or stored by separate (e.g., remote) systems. For example, in some embodiments the computer models are not stored at the release generation system 110, in which case the computer models may be stored at a remote system and accessed by the release generation system 110. The release generation system 110 in these embodiments may provide information for training (or fine-tuning) the models and may send requests to the external systems for accessing and applying the models. As such, “training” the model may include sending data to another system that performs the training based on provided training data, and similarly using a model may include sending input data to another system for training the model.

The authoring interface module 310 interfaces with a user (also referred to as an author) for generating a press release, selecting desired distribution channels and/or destinations, and sending a finalized release for distribution. The authoring interface module 310 may interact with various modules and models for assisting in generation of the release and its distribution channels. In general, the authoring interface module 310 may send information for presentation to the author in one or more interfaces displayed on the author's device and receive selections from the author to navigate the interfaces and assemble a press release for distribution. The authoring interface 310 may receive a set of core concepts from the author representing the information to be disseminated by the press release. The core concepts may differ in each press release and may vary according to the type of release. The core concepts may be one or more “facts” to be conveyed by the statement and may generally be short textual statements (e.g., a bullet-point list) of textual words or terms. The core concepts in some embodiments may also include a type or classification of the core concept. As one example, for a press release relating to an acquisition, the core concepts may be “BigCo closed deal to acquire SmallCo,” “SmallCo is a leading provider of general language models,” “BigCo is hiring SmallCo CEO John Doe, PhD,” “John Doe is an inventor of 5 patents with SmallCo,” “The acquisition value of SmallCo is $100 M,” and “Deal is expected to close on October 1.” As shown in this example, the core concepts may represent short, concrete, factual information to be conveyed in the press release.” In addition to the informational/factual content, the core concepts may also include a title, images, video, references (e.g., links), and other information to be included in the press release. The core concepts may thus include any informational or substantive content that may be used as input for automatic generation of a press release.

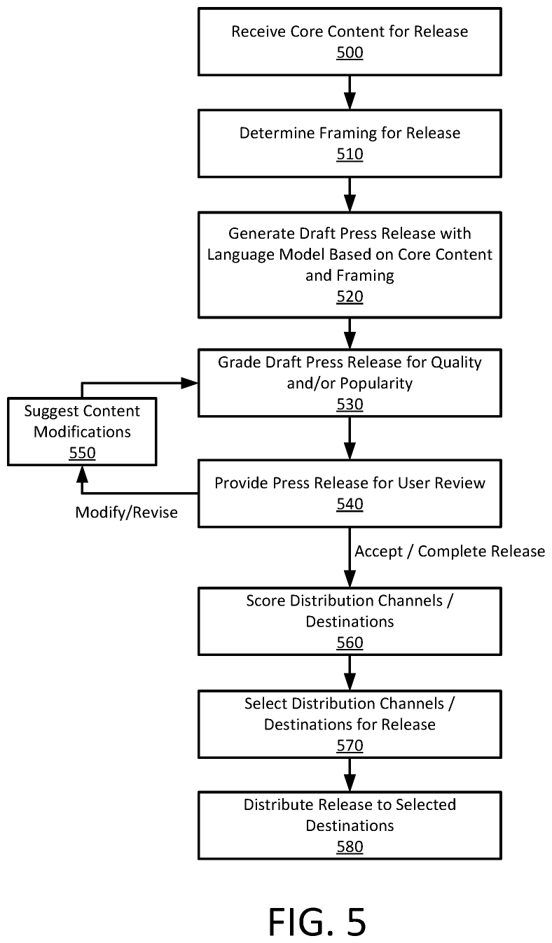

To generate a press release that optimizes for audience engagement and for various destinations, the authoring interface module 310 determines a framing for the press release in conjunction with the author. The framing may describe a particular tone and/or associated keywords desired for the press release. The core concepts and framing may then be used to automatically generate a draft press release for the author to further modify, and for which the author may select distribution channels and/or destinations for distributing the release. To generate the release, the core concepts and/or framing may be combined to generate an input or “prompt” to a large language model as discussed below with respect to the release generation module 370. The large language model generates a press release as an output based on the prompt to the model. The authoring interface may then present the press release for further modification and editing by the author, which may include adding more core content, such as images, references, and so forth. The authoring interface may also coordinate grading of the release by a standards grading module 340, and provides real-time suggestions to the author when modifying the press release based on the framing for the press release. After completing the release, the authoring interface 310 may also coordinate with a destination recommendation module 350 to suggest destinations for the release. Further details of these processes for authoring and distribution are discussed below, and in particular with respect to FIG. 5.

An audience analysis module 320 collects information relating to the performance of a press release. The audience analysis module 320 may determine, from the distribution channels, information about the audience viewing or otherwise interacting with the press release, such as a total number of views, a total reach of the press release (e.g., unique viewers), total distribution, number of users who interacted with links in the press release, and so forth. The audience analysis module 320 may also associate information about individual destinations and, if determinable, metrics about engagement of further audiences with content with destination channels. For example, in the example of FIG. 2, destination 140C generated an independent publication 220 that related to the press release 200. Information may be available regarding the engagement of audiences with the destination channel in which the independent publication 220 is published, such as its audience size, interactions, and so forth. For example, when the publication 220 is distributed in a newspaper or television program, an audience size may be estimated for that distribution. Similarly, a destination channel on a social media platform may include audience interactions such as views, shares, mentions, etc., on the social media platform. These and other audience metrics may be collected by the audience analysis module 320 and stored in association with a press release in the historical release data store 380.

The audience analysis module 320 may also analyze content and/or other interactions from a destination to determine whether an action by the destination is attributable to the press release (i.e., is the press release causally related to the further publication by the destination). While in some situations it may be apparent (e.g., a destination shares the press release or publishes a verbatim or summarized version), in some situations, the audience analysis module 320 may further analyze content of the interaction to determine an attribution for the destination. For example, an effective press release for a company may result in an interview with a representative of that company relating to the subject of the press release. In some embodiments, the attribution is determined based on backlinks (e.g., references or other links to the press release) and content similarity of the publication by the destination. In additional embodiments, activity from a destination may be considered attributable to the press release when it relates to a core concept of the press release and/or when it occurs within a particular timespan of the press release. In one embodiment, the audience analysis module 320 may include a web crawler that collects and analyzes interactions and content from destinations and evaluates content similarity to the press release. A destination's interaction (e.g., a publication) for similar content (e.g., a similarity score over a threshold) may be considered attributable to the press release. These may be used, for example, to identify when a journalist (or influencer or other destination) reads the press release.

A framing classification module 330 may be used to identify one or more topics, a tone, and/or keywords in a press release. In general, in generating/authoring a release, the topic and tone for the release may be used to suggest terms and/or keywords for inclusion in a press release to increase the likelihood that the press release will have increased audience engagement or will be picked up by a destination. To do so, the related topic and/or keywords for historical releases may also be determined so that the relationship between the topic/keywords (e.g., the framing) of the historical releases and audience metrics may be determined. The framing classification module 330 may be used to determine a framing for historical releases and to suggest the same for new releases. A tone may refer to a particular way or style of presenting information of the press release and may be associated with particular keywords or phrases. The characterization of keywords as a “tone” may be useful in providing selections to a press release author, such that the author may select a tone such as “conservative” or “formal” or “cool and breezy” to select the intended stylistic effects on the text, rather than individually choosing particular terms or phrases to cause that effect. In some embodiments, the label for a tone is determined based on a grouping of associated keywords.

In some embodiments, the particular topics or tones and the associated keywords may be predetermined and/or defined by another user or system. For example, hierarchy of topics, styles, and/or tones may be pre-associated with keywords and terms determined from a general language model or on a data corpus unrelated to press releases.

As such, in some embodiments, the framing classification module 330 may use a pre-trained model for identifying topics, a tone, and/or keywords in a release. In other embodiments, previous press releases may be used as training data for a model, either to train topic/tone detection or to fine-tune pre-existing model parameters. In one embodiment, a set of previous press releases may be labeled with respect to particular tones and/or tone-related keywords and used to extract information to identify tones and/or keywords for un-labeled press releases. As one example, a set of press releases labeled with a set of tones may be used as training data to train a model to predict one or more tones (e.g., as a classification problem) for an unlabeled press release. In one embodiment, a tone may be predicted from the text of the press release directly; in further embodiments, a tone may be predicted based on identification of tone-related keywords in the press release. In additional or alternative embodiments, press releases labeled with a tone may be used to determine keywords associated with that tone, such that the model may infer the tone of a press release based on the presence of the keywords (and the keywords may be suggested to an author who would like to use that tone). As one example, a set of labeled press releases may be analyzed to identify keywords that appear in relatively higher frequency for press releases labeled with a particular tone and identify those keywords (e.g., the highest-frequency keywords) as indicative of the tone. In addition, the framing classification module 330 may identify example press releases most representative of a particular tone, such that an example of each tone may be provided to an author in determining a tone that may be used for a particular press release.

A standards grading module 340 determines a “grade” for a press release describing its quality according to industry standards or other objective measures or rules. In addition to industry standards, the standards grading module 340 may also grade a press release based on guidelines and objectives for a given entity. In some circumstances, keywords and other tones that may be effective at drawing an audience may be undesirable with respect to these standards, thus determining a grade of a press release with respect to the standards may enable new press releases to both be effective based on the audience metrics but also while maintaining high quality according to the standards.

To analyze a press release, the content of the press release, such as its text, images, video, and so forth, may be decomposed into individual segments. The segments may then be analyzed by a rules matching engine, which identifies a set of rules and/or quality evaluation criteria for the respective segment. The particular rules for evaluating quality of the segment may differ for different authors and/or entities; for example, one entity may have rules related to formatting and style of a title for the press release that differ from that of another entity. Each segment may then be analyzed with the rules and natural language processing algorithms to score specific attributes of each segment. The scores for each segment may then be consolidated or otherwise combined to generate a “grade” for the press release as a whole. In some embodiments, the standards grading module 340 may also identify specific segments and/or rules that reduced the grade and/or portions of the press release that violated a rule, such that the portion of the press release that resulted in the reduced grade can be identified to the author.

The channel recommendation module 350 is used to evaluate the likely responses to a published press release for various distribution channels, which may include individual destinations. That is, the channel recommendation module 350 may evaluate and/or suggest individual distribution channels (e.g., different active and/or passive distribution channels) and/or individual destinations to which the press release should be distributed. In some situations, the press release may be distributed to a limited group of distribution channels and/or destinations, or certain press releases may be appropriate only for certain channels.

The channel recommendation module 360 may use computer models to match the tone or topic of the press release with historical articles published in popular journals. A topic classification module may use language processing modules to determine topic of published articles. The channel recommendation module then uses the draft press release topic and matches with article topics to determine outlets and journalists that may potentially be interested in writing similar or follow up articles. The channel recommendation engine suggests these outlets or journalists to the press release author.

The channel recommendation module 360 may use computer models to predict the audience metrics and/or destination response (e.g., likelihood of one or more actions by the destination to further publicize to its destination channels) for a press release based on the collected audience metrics for historical press releases in the historical release data store 380. These metrics may describe, for example, the distribution channels and destination channels for prior press releases and the related audience in terms of views, reach (i.e., unique users/viewers), and so forth. To generate these predictions, the popularity prediction module may train a model to predict audience metrics for different distribution channels and destinations based on characteristics of a draft press release, which may include the core content, topic, framing (e.g., the tone), the press release content (for a completed draft press release), and any related metadata. In one embodiment, particular audience metrics for a distribution channel (e.g., views), are predicted as a specific value by a computer model, and in other embodiments may be a predicted range or category (e.g., 100-1,000 views, 1,000-5,000 views, etc.). In some embodiments, an overall number of actions by destinations of interest may be similarly predicted (e.g., 100 “shares” on a social media platform by relevant entities (e.g., specified as destinations or users with more than 100,000 followers)).

In one embodiment, an action (e.g., a share, an independent article, separate publication, etc.) by a particular destination is predicted as a binary value representing a classification of “yes” or “no” for that destination with respect to that action. For example, in one embodiment the number of total destinations of interest may be relatively limited, such that a classifier for an action may be trained for each destination. For example, a number of business journalists may be relatively limited, such that a classifier may be trained for each with respect to the likelihood that an article (or other content) is published to the respective journalist's destination channels. The model may be a multi-headed model, such that each head of the model predicts a different type of action that a destination may take (e.g., a mention, share, link, independent publication, etc.).

In addition, a destination prediction model for destination actions may include features describing the destination as one input to the model, such that the trained model may be used for many different destinations. As one way of doing so, in one embodiment a destination is represented as an input to the model as a learned embedding representing features of the destination. For example, a destination may be represented based on prior content that the destination has interacted with or published. The prior content (that the destination engaged with) may be characterized based on its topics, terms, tone, keywords, and so forth, such that the destination may be characterized in the model. The topics, tone, keywords, and other information about the content engaged with by the destination may be determined by various means, and in one example is generated by an analysis by the framing classification module 330. In one embodiment, the features about a destination (e.g. the destination's engagement with press releases) are characterized in a destination embedding generated by a learned computer model. The destination embedding may then be input to the destination prediction model along with relevant input for the current press release to predict the articles engaged with by any destination that can be characterized by its engagement with content. In any of these ways, the likely response of a destination can be determined for a prospective press release based on one or more of the topic, tone, keywords, and/or content of the press release.

In one embodiment, the prediction of channels and/or destination responses may be used to select distribution channels and/or destinations to receive the press release. For example, a completed press release may be input to the model and evaluated to predict the likely response from different channels and/or destinations. In some embodiments, this may be used to automatically select channels and/or destinations for distributing the press release. In additional embodiments, the selected channels/destinations may be suggested to an author, who may add or remove channels informed by the predicted response.

In one embodiment, the prediction of channel/destination response is used to inform an author in selecting a framing for the press release. In this circumstance, one or more prospective target channel/destination may be selected, and a prediction is made when the tone/keywords are varied for a given press release. For example, an author may indicate one or more prospective target channels/destinations for evaluation and may additionally provide the core content for a press release, from which a topic may be determined (or entered by the author). Based on the historical interactions by the channels/destinations (e.g., as represented in the parameters of the trained model), a prediction may be made for a response related to particular framing (e.g., tones and/or keywords) that may increase audience metrics and/or destination actions. For example, an author may indicate the press release relates to a new research discovery for blood analysis tools and designate a health journalist at a major newspaper as a target destination. The topic of blood analysis tools may be input to the model with simulations of various tones that may be taken with the topic, such as “short-term focus” “long-term focus” “formal” “hopeful” and so forth, such that predictions for the respective tones are generated and presented to the user (along with associated keywords and phrases that are associated with that tone). This enables the press release to adopt that tone, guided by associated keywords and phrases (e.g., based on associations from the framing classification module 330), thereby increasing the likelihood that the particular health journalist will engage with the press release. Multiple such target distribution channels and/or destinations may be similarly evaluated, so that a selected tone for the press release may account for the different effects across different channels and destinations. As such, the channel recommendation module 350 along with the topic and framing analysis enable prospective prediction of press release interactions and customization of such releases on that basis.

A release generation module 360 may use a large language model to automatically generate a press release for an author. A large language model may represent individual words or terms as tokens with associated token embeddings, with learned parameters to determine how to sequence tokens. In some embodiments, a large language model may be structured as a transformer in which an input sequence is transformed by the model into an output sequence of output tokens, in which the input and output token lengths may be different. These models may also include an attention and/or self-attention elements, such that the output tokens may be sequenced and be chosen with knowledge of the other selected output tokens. Such models may be termed “large” because many such models are trained on very large training data sets, such as crawled natural language on the Internet, from books, and other corpuses of large data sets. These models may also learn a large number of parameters (e.g., billions or trillions). Although in some instances a large language model may be stored at the release generation system 110, given the model size and training effort for such models, in many instances the release generation module 360 coordinates communication with another system that operates the large language model. As such, the release generation module 360 may generate an appropriate “input” to the large language model for the generation and/or modification of a press release, send the input to the large language model, and receive the output as a press release. The input to the large language model may also be referred to as a “prompt” as the large language model may also be configured to respond to the inputs phrased as instructions or as questions for which the “output” is a response to the instruction or question.

To generate the press release, the release generation module receives the core concepts and a framing (e.g., tone and/or keywords) from the authoring interface module 310 and generates a prompt for the large language model. The prompt may take different forms depending on the particular large language model and may be constructed in different ways, such that in some embodiments multiple prompts are generated that correspond to multiple generated press releases, which may be presented to the author for selection of a preferred release.

The particular structures of the prompt and ways of combining the input information about a press release vary in different embodiments and may be designed by an operator of the release generation system 110. In some embodiments, the release generation module 360 may have one or more templates for generating a prompt. A template may provide text and/or instructions for converting the press release information into a corresponding prompt. For example, the templates may provide introductory and connecting text with one or more blanks for the received information, such as “Create a press release that discusses information including ______ in a tone of ______ that may use the following terms ______” in which the core information is inserted in the first blank, the tone is inserted in the second blank, and keywords/terms associated with the tone are inserted in the third blank. In some embodiments, the release generation module 360 may generate the press release with a sequence of prompts (which is a “type” of template). For example, a first prompt may ask the large language model to write a brief summary of the core concepts, without reference to a tone. Then a second prompt may ask the model to rewrite that information in the style of a press release using the designated tone and to consider the suggested keywords as indicative of that tone. The generated output from the large language model may then be provided to the authoring interface module for presentation to the author for editing or distribution. In some embodiments, the author may provide suggestions in terms of adjusting the tone or keywords or other information of the press release, in which case the release generation module 360 may generate an additional prompt for the large language model to generate a modified press release.

As referenced above, in many cases large language models may initially be trained on a very large corpus of data that provide a high level of generalized application. To further improve the large language models, in some embodiments the release generation module 360 may further provide training data examples to the large language model for fine-tuning of the large language model for drafting effective press releases based on the available information to the release generation system 110.

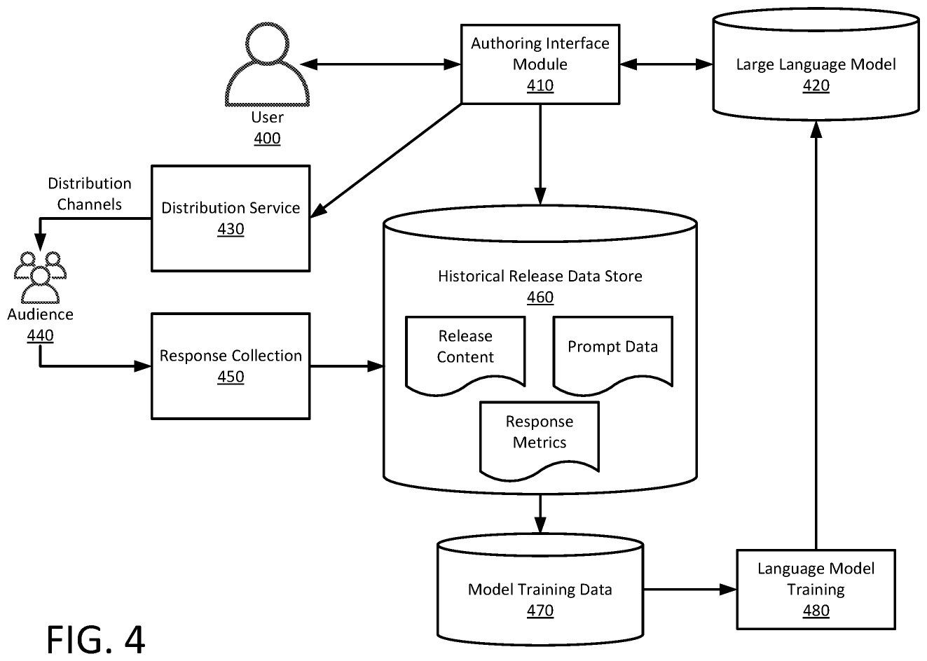

FIG. 4 provides an interaction diagram for using and fine-tuning a large language model for generating effective press releases, according to one or more embodiments. As discussed above, a user may interface with an authoring interface module 410 (which may operate similarly to authoring interface module 310) to generate a press release. The user 400 provides a set of core concepts and selects a framing for the press release (e.g., in conjunction with a recommended tone for the release). The authoring interface module 410 coordinates (e.g., with a release generation module 360) with the large language model 420 to generate a press release based on the core concepts and the framing. The user 400 may edit the press release to finalize it and select distribution channels for the press release. A distribution service 430 sends the press release to the respective channels, which may be interacted with by an audience 440. Response collection 450 for the audience generates a set of response metrics, such as the viewership or reach of the press release.

Information about the press release and its audience response is collected in a historical release data store 460. The historical release data store 460 may include any relevant aspects of the press release generation and audience response that may be relevant to fine-tuning the large language model. In particular, the historical release data store 460 may include the release content, such as its textual content, title, links/references, and other content distributed with the press release. The historical release data store 460 may also include data relating to the prompt used as an input to the large language model 420. For example, the prompt data may include the core concepts input by the author, the tone and/or keywords, and in some embodiments may include the specific prompt that was input to the large language model 420. In other examples, the constituent data (e.g., the core concepts and framing) may be used such that training data with different particular prompts may be generated with different processes.

As large language models are often configured to generate text directly based on examples of token sequences, such large language models may not directly be able to incorporate aspects of whether a press release was particularly effective or ineffective. In addition, such large language models may not be capable of directly learning based on negative training examples or to directly train “towards” a preferred example and away from a disfavored example. As such, rather than providing all press releases and related prompts to the large language model as training data, in some embodiments model training data 470 is selected from the press releases that performed particularly well. For example, the response metrics for the press releases may be evaluated with respect to a threshold or with respect to one another (e.g., to select a number of relatively highest-performing releases) to select which historical examples to provide as (positive) training examples to the large language model 420. The training data may then be generated from the selected historical press releases such that each training data example includes an input prompt in the same or similar form that future prompts may be provided (e.g., by the release generation module 360). The training data may then include an output as the content of the distributed historical press release (which may include the author's modifications relative to a previously-generated press release by the large language model for the same core content and framing). In some examples, the training data 470 may be generated from press releases that were not originally generated by the large language model. The respective prompt as an input for training data of that release may be generated for the release (e.g., based on a detected framing and/or core concepts) as additional training data for the large language model 420. The input/output training examples in the model training data 470 may then be used by a language model training 480 process to fine-tune the large language model 420. In embodiments in which the large language model 420 is stored at a remote system, the training data may be provided to the remote system for application to the model.

FIG. 5 is an example flowchart for automating generation and distribution of a press release, according to one or more embodiments. The process of FIG. 5 may be performed by a release generation system, such as release generation system 110, and illustrates the orchestration of various services, for example via an authoring interface module 310 for providing effective selection of framing, press release generation, and distribution selection. Initially, an author may access the release generation system and the system may provide one or more interfaces on which information about the press release may be provided and on which the user may make selection and otherwise provide information for authoring and distributing the press release. As such, interactions with the user may include sending respective information to a device operated by the user for display of the related information and receipt of user interactions by the device are provided by the device to the release generation system.

Initially, the user may provide a set of core content for the press release that is received 500 by the release generation system. To aid the user in crafting the release for improved audience reception and destination engagement, the system may also determine a framing for the release 510, which may include a tone and one or more keywords associated with the tone. In some embodiments, the user is presented with an interface for selecting a tone, e.g., from a predefined list of tones. Each tone may also be presented to the user along with a set of associated keywords and an example press release of that tone. In some embodiments, a tone may also be suggested to the user based on a tone of the user's previous press releases or based on prior releases of an entity affiliated with the user.

In some embodiments, the framing may be determined based on one or more target destinations for the press release. In these embodiments, the author may select (or have suggested) one or more target distribution channels and/or destinations that may be of interest. The target distribution channels and/or destinations may be based on prior targets of the user and/or the core content of the press release. For example, a topic may be determined based on the core content and used to evaluate the likely audience metrics of different channels/destinations to that topic. From the selected destinations, tones may be evaluated to predict the tones that most positively affect the likely audience metrics or destination engagement as discussed above. The effective tones may then be presented along with related keywords to the user for selection as the framing for the press release. In some embodiments, the framing may be automatically determined for the user based on the distribution channels.

Next, a press release may be automatically generated 520 for the user based on the core concepts and the framing. The core concepts and framing may be used to create a set of inputs e.g., as a prompt, to a large language model that may generate the press release as an output based on the informational content of the core concepts and in a linguistic style according to the specified framing as also discussed above. In addition, the generated press release may also be graded 530 with respect to objective standards, for example by the standards grading module 340 discussed above. In some embodiments, multiple press releases may be generated, e.g., based on different templates or prompts used by a release generation module 360, in which case the user may select one generated press release to further modify and/or distribute.

The generated press release and its grade, along with any other details, may be provided to the user for review and further modification. As the user modifies the press release, the system may provide additional suggestions 550 for content modification, for example by providing keywords and phrases related to the selected framing for incorporation by the user in the draft. The system may also include auto complete and suggested terms for completing sentences or paragraphs by the user. In addition, the draft press release may also be analyzed to determine a tone of the press release and the user may be notified if the current tone of the release differs from the selected tone, and the different tone may also be evaluated with respect to desired distribution channels to identify a likely effect of the different tone on the audience metrics. As such, when the author modifies the press release, the author may be informed with respect to the likely effects with respect to the changing tone of the press release with respect to the desired downstream impact. After modification, the modified release may be re-graded 530 and the updated grade presented to the user.

When the user indicates that the press release is complete, the user may be presented with interfaces for evaluating and selecting distribution channels for the press release (e.g., which may include which destinations may view the press release). To do so, the different distribution channels and/or destinations may be scored 560 to predict audience metrics and likelihood of destination interactions as discussed above with respect to the channel recommendation module 350. As also discussed above, the scoring may be based on an analysis of the completed press release, such as its topic, tone, content, etc., such that the distribution channel may be selected and optimized to improve the audience metrics based on the release. In some embodiments, a set of channels may be initially suggested to the author based on prior selections by the user, and an initial set of distribution channels may be automatically determined based on the scoring 560. The user may then edit the distribution channels to add or remove distribution channels and may do so with consideration of the predicted metrics of the related channels. After selection of the distribution channels, the release may then be distributed 580 along the selected distribution channels and to the selected destinations.

Together, this approach provides a means for providing automated assistance to improve press release generation and distribution by optimizing information and framing according to historical responses to releases in different channels and by different destinations. In addition, by tracking metrics of audiences and destinations, effective training data may be used to inform the communication style and framing for a press release up front and incorporate such data in the automatic generation of draft press releases, both shortening the time required to create a press release but also increasing its effectiveness and audience. This may be particularly important in the improved ability to incorporate framing that is effective with independent entities (as destinations for the press release) with whom the authoring entity typically may have a limited direct ability to interest.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving a set of core content for distribution in a press release;
determining a framing for the press release;
generating a draft press release with a large language model based on the set of core content and the framing;
measuring historical success rates and popularity of historical releases via the audience analysis module and historical release data store;
automatically determining, based at least on the framing or the set of core content or including historical release data of similar framing, core content or past releases for related entities, a grade for the press release, wherein the grade (measuring expected success of the release) is determined for a generated press release that can be used to further modify the release if the grade is lower than expected;
automatically determining, based at least on the framing or the set of core content, one or more distribution channels for the press release; and
sending the press release to the one or more distribution channels.

2. The method of claim 1, wherein the framing describes a tone or a set of key phrases for use in the press release.

3. The method of claim 1, wherein generating the press release further comprises generating a prompt for the large language model based on the set of core content and the framing.

4. The method of claim 1, wherein the determination of one or more distribution channels is based on a computer model prediction of response metrics for the distribution channels

5. The method of claim 1, wherein determining the framing comprises applying a computer model that predicts a likelihood that one or more target destinations generate additional content for the press release based on the framing.

6. The method of claim 1, further comprising:
selecting one or more historical press releases based on release response metrics;
for the selected one or more historical press releases, generating a training data example including prompt data for the historical press release and content of the historical press release; and
providing the training data example for fine-tuning of the large language model with a prompt based on the training data and a response based on the content of the historical press release.

7. The method of claim 1, further comprising:
providing an interface for display on a user device, wherein the core content is received from the user device via the display;
receiving a user selection of the framing from the user device;
providing the press release on the interface for display to the user on the user device;
receiving a modification of the press release based on received interactions from the user;
applying the modification to the press release;
generating suggested text based on the modification and the framing for the press release; and
providing the suggested text for display with the modified press release to the user on the interface of the user device.

8. One or more non-transitory computer-readable media having instructions executable by one or more processors for:
receiving a set of core content for distribution in a press release;
determining a framing for the press release;
generating a draft press release with a large language model based on the set of core content and the framing;
measuring historical success rates and popularity of historical releases via the audience analysis module and historical release data store;
automatically determining, based at least on the framing or the set of core content or including historical release data of similar framing, core content or past releases for related entities, a grade for the press release, wherein the grade (measuring expected success of the release) is determined for a generated press release that can be used to further modify the release if the grade is lower than expected;
automatically determining, based at least on the framing or the set of core content, one or more distribution channels for the press release; and
sending the press release to the one or more distribution channels.

9. The one or more non-transitory computer-readable media of claim 8, wherein the framing describes a tone or a set of key phrases for use in the press release.

10. The one or more non-transitory computer-readable media of claim 8, wherein generating the press release further comprises generating a prompt for the large language model based on the set of core content and the framing.

11. The one or more non-transitory computer-readable media of claim 8, wherein the determination of one or more distribution channels is based on a computer model prediction of response metrics for the distribution channels

12. The one or more non-transitory computer-readable media of claim 8, wherein determining the framing comprises applying a computer model that predicts a likelihood that one or more target destinations generate additional content for the press release based on the framing.

13. The one or more non-transitory computer-readable media of claim 8, the instructions further executable by the one or more processors for:
selecting one or more historical press releases based on release response metrics;
for the selected one or more historical press releases, generating a training data example including prompt data for the historical press release and content of the historical press release; and
providing the training data example for fine-tuning of the large language model with a prompt based on the training data and a response based on the content of the historical press release.

14. The one or more non-transitory computer-readable media of claim 8, the instructions further being executable by the one or more processors for:
providing an interface for display on a user device, wherein the core content is received from the user device via the display;
receiving a user selection of the framing from the user device;
providing the press release on the interface for display to the user on the user device;
receiving a modification of the press release based on received interactions from the user;
applying the modification to the press release;
generating suggested text based on the modification and the framing for the press release; and
providing the suggested text for display with the modified press release to the user on the interface of the user device.

15. A computing system comprising:
one or more processors; and
one or more computer-readable media having instructions executable by the one or more processors for:
receiving a set of core content for distribution in a press release;
determining a framing for the press release;
generating a draft press release with a large language model based on the set of core content and the framing;
measuring historical success rates and popularity of historical releases via the audience analysis module and historical release data store;
automatically determining, based at least on the framing or the set of core content or including historical release data of similar framing, core content or past releases for related entities, a grade for the press release, wherein the grade (measuring expected success of the release) is determined for a generated press release that can be used to further modify the release if the grade is lower than expected;
automatically determining, based at least on the framing or the set of core content, one or more distribution channels for the press release; and
sending the press release to the one or more distribution channels.

16. The computing system of claim 8, wherein the framing describes a tone or a set of key phrases for use in the press release.

17. The computing system of claim 15, wherein generating the press release further comprises generating a prompt for the large language model based on the set of core content and the framing.

18. The computing system of claim 15, wherein the determination of one or more distribution channels is based on a computer model prediction of response metrics for the distribution channels

19. The computing system of claim 15, wherein determining the framing comprises applying a computer model that predicts a likelihood that one or more target destinations generate additional content for the press release based on the framing.

20. The computing system of claim 15, wherein the instructions are further executable by the one or more processors for:
selecting one or more historical press releases based on release response metrics;
for the selected one or more historical press releases, generating a training data example including prompt data for the historical press release and content of the historical press release; and
providing the training data example for fine-tuning of the large language model with a prompt based on the training data and a response based on the content of the historical press release.
